(19) United States
(12) Patent Application Publication
(10) Pub. No.: US 2026/0253226 A1
(43) Pub. Date: Aug. 27, 2026

(54) METHOD FOR PERFORMING VIDEO SEGMENTATION OF VIDEO WITH SELECTIVE USAGE OF SEGMENTATION ENGINE, AND ASSOCIATED APPARATUS

(71) Applicant: MEDIATEK INC., Hsinchu City (TW)

(72) Inventors: Hung-Wei Chih, Hsinchu City (TW); Po-Yu Yeh, Hsinchu City (TW); Shen-Kai Chang, Hsinchu City (TW); Ming-Chang Chuang, Hsinchu City (TW); Po-Yu Huang, Hsinchu City (TW); Ching-Kan Tseng, Hsinchu City (TW); Po-Wen Yang, Hsinchu City (TW); Jou-Feng Huang, Hsinchu City (TW)

(73) Assignee: MEDIATEK INC., Hsinchu City (TW)

(21) Appl. No.: 19/533,317

(22) Filed: Feb. 9, 2026

Related U.S. Application Data
(60) Provisional application No. 63/763,334, filed on Feb. 26, 2025.

(51) Int. Cl. G06T 7/11; G06T 7/20; G06V 10/74

(52) U.S. Cl. CPC G06T 7/11; G06T 7/20; G06V 10/761; G06T 2207/10016

(57) ABSTRACT

A method for performing video segmentation of a video with selective usage of a segmentation engine and associated apparatus are provided. The method includes: performing a first video segmentation operation on a first image frame of the video with the segmentation engine, in order to divide the first image frame into multiple first regions, for performing image processing of the multiple first regions, respectively; and performing a second video segmentation operation on a second image frame of the video at least according to correlation information associated with the second image frame and the first image frame, without using the segmentation engine, in order to divide the second image frame into multiple second regions, for performing image processing of the multiple second regions, respectively. The first video segmentation operation can generate a first map, and the second video segmentation operation can be performed according the correlation information and the first map.

### CROSS REFERENCE TO RELATED APPLICATIONS

This application claims the benefit of U.S. Provisional Application No. 63/763,334, filed on Feb. 26, 2025. The content of the application is incorporated herein by reference.

### BACKGROUND

The present invention is related to video processing, and more particularly, to a method for performing video segmentation of a video with selective usage of a segmentation engine, and associated apparatus such as an embedded system, an electronic device, etc.

According to the related art, power-saving may be regarded as one of the crucial topics in most embedded systems and edge products. For example, in computer vision, high-quality segmentation such as that using artificial intelligence (AI) typically requires relatively heavy computation, and the AI-based segmentation architecture may get better quality in comparison with the non AI-based segmentation architecture, but would consume a large amount of system resources and lead to high power consumption. It seems that there is no proper solution in the related art. Thus, a novel method and associated architecture are needed for solving the problem without introducing any side effect or in a way that is less likely to introduce a side effect.

### SUMMARY

It is an objective of the present invention to provide a method for performing video segmentation of a video with selective usage of a segmentation engine, and associated apparatus such as an embedded system, an electronic device, etc., in order to solve the above-mentioned problem.

At least one embodiment of the present invention provides a method for performing video segmentation of a video with selective usage of a segmentation engine, where the method may comprise: performing a first video segmentation operation on a first image frame of the video with the segmentation engine, in order to divide the first image frame into multiple first regions, for performing image processing of the multiple first regions, respectively; and performing a second video segmentation operation on a second image frame of the video at least according to correlation information associated with the second image frame and the first image frame, without using the segmentation engine, in order to divide the second image frame into multiple second regions, for performing image processing of the multiple second regions, respectively. For example, the first video segmentation operation can be performed on the first image frame of the video with the segmentation engine to generate a first map corresponding to the first video segmentation operation, for indicating the multiple first regions of the first image frame, respectively. In addition, the second video segmentation operation can be performed on the second image frame of the video at least according to the correlation information associated with the second image frame and the first image frame as well as the first map to generate a second map corresponding to the second video segmentation operation, for indicating the multiple second regions of the second image frame, respectively.

At least one embodiment of the present invention provides an apparatus that operates according to the method mentioned above, where the apparatus comprises a processing circuit for controlling the video segmentation and selectively using the segmentation engine during the video segmentation. For example, the apparatus can be implemented as an embedded system. In another example, the apparatus can be implemented as an electronic device. According to some embodiments, the processing circuit and the segmentation engine can be implemented by way of at least one integrated circuit (IC) such as one or more ICs. For example, the segmentation engine can be implemented by way of one of the following: an accelerated processing unit (APU), a specific hardware circuit outside the processing circuit, and a library running on the processing circuit.

It is an advantage of the present invention that, the proposed method (i.e., the aforementioned method for performing the video segmentation of the video with the selective usage of the segmentation engine) of the present invention, as well as the associated apparatus such as the embedded system, the electronic device, etc., can realize a lightweight architecture in video processing to get desired results without performing inference each frame of the video by using the segmentation engine, and more particularly, can make it possible to predict the segmentation mask (which may also be referred to as the segmentation map, or “the map” for brevity) for the current frame by using historical inferred data, sensor information and the current image. As a result, power efficiency can be benefited by reducing calling times of the power consuming segmentation engine. In addition, the proposed method of the present invention and the associated apparatus can solve the related art problem without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an apparatus for performing video segmentation of a video with selective usage of a segmentation engine according to an embodiment of the present invention, where the apparatus can operate according to the proposed method.

FIG. 2 illustrates a video segmentation and image processing control scheme of the proposed method according to an embodiment of the present invention.

FIG. 3 illustrates some operations in a single type segmentation control scheme according to an embodiment of the present invention.

FIG. 4 illustrates some operations in a hybrid type segmentation control scheme of the proposed method according to an embodiment of the present invention.

FIG. 5 illustrates a hybrid control architecture involved with the hybrid type segmentation control scheme of the proposed method according to an embodiment of the present invention.

FIG. 6 illustrates a boundary processing control scheme of the proposed method according to an embodiment of the present invention.

FIG. 7 illustrates some operations in the hybrid type segmentation control scheme of the proposed method according to another embodiment of the present invention.

FIG. 8 illustrates some operations in the hybrid type segmentation control scheme of the proposed method according to yet another embodiment of the present invention.

FIG. 9 illustrates, in the sub-diagram (b) thereof, a processing result involved with the hybrid type segmentation control scheme of the proposed method according to an embodiment of the present invention, where some processing result involved with the single type segmentation control scheme and a single type segmentation and power saving control scheme are respectively illustrated in the sub-diagrams (a) and (c) of FIG. 9 for better comprehension.

FIG. 10 illustrates a main working flow of the proposed method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

Video segmentation can be regarded as a process of dividing each frame of a video into multiple regions based on certain features such as object boundaries, color, texture, and/or other visual characteristics. When image processing with segmentation technique is applied onto the video, for example, under control of a processing circuit, the processing circuit can identify one or more local areas (e.g., one or more regions among the multiple regions as determined by the video segmentation) and do corresponding local adjustments for each frame. For better comprehension, the corresponding local adjustments may comprise operations of making the sky area bluer, increasing the saturation of the portrait area, etc., but the present invention is not limited thereto. In addition, in computer vision, high-quality segmentation such as that using AI typically requires relatively heavy computation, and the AI-based segmentation architecture may get better quality in comparison with the non AI-based segmentation architecture, but would consume a large amount of system resources and lead to high power consumption. Embodiments of the present invention provide a method for performing video segmentation of a video with selective usage of a segmentation (Seg) engine, as a lightweight methodology in the video processing architecture, to get desired results without inferring each frame of the video by using the segmentation engine (which may also be referred to as the Seg Engine as shown in some figures for brevity), and more particularly, predict the segmentation mask/map (or “the map” for brevity) for the current image frame by using auxiliary information such as historical inferred data, sensor information, the current image frame, etc. As a result, power efficiency can be benefited by reducing calling times of the power consuming segmentation engine.

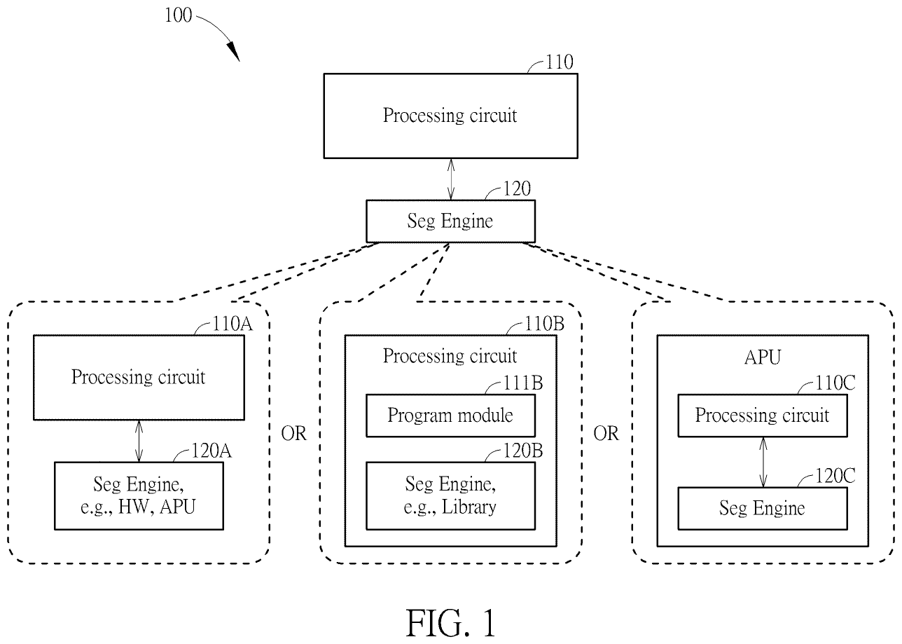

FIG. 1 is a diagram illustrating an apparatus 100 for performing video segmentation of a video with selective usage of a segmentation engine according to an embodiment of the present invention, where the apparatus 100 can operate according to the proposed method such as the method mentioned above. For example, the apparatus 100 can be implemented as an embedded system, but the present invention is not limited thereto. In another example, the apparatus 100 can be implemented as an electronic device. In some examples, the apparatus 100 at least comprises the embedded system, and the embedded system can be positioned in the electronic device. As shown in FIG. 1, the apparatus 100 may comprise a processing circuit 110 and the segmentation engine such as the Seg Engine 120. In the proposed architecture of the apparatus 100, the processing circuit 110 (or a main program module running thereon) can be configured for controlling the video segmentation, the associated image processing, etc. and selectively using the Seg Engine 120 during the video segmentation, and the processing circuit 110 and the Seg Engine 120 can be implemented by way of at least one integrated circuit (IC).

According to different design concepts, the Seg Engine 120 can be either positioned outside the processing circuit 110 or integrated into the processing circuit 110. For the case that the Seg Engine 120 is positioned outside the processing circuit 110, the processing circuit 110 and the Seg Engine 120 can be implemented as the processing circuit 110A and the Seg Engine 120A, respectively. In this architecture, the Seg Engine 120A can be implemented by way of a dedicated circuit such as a specific hardware (HW) circuit outside the processing circuit 110A, an APU (or any sub-circuit thereof), etc. (labeled “HW, APU” for brevity), for being called and/or invoked by the processing circuit 110A (or the main program module running thereon). For the case that the Seg Engine 120 is integrated into the processing circuit 110, the processing circuit 110 and the Seg Engine 120 can be implemented as the processing circuit 110B and the Seg Engine 120B, respectively. In this architecture, a program module 111B running on the processing circuit 110B can act as the main program module for controlling the video segmentation, the associated image processing, etc. and selectively using the Seg Engine 120B during the video segmentation, and the Seg Engine 120B can be implemented by way of a library running on the processing circuit 110B, to act as a secondary program module for being called by the main program module. This is for illustrative purposes only, and is not meant to be a limitation of the present invention. In some examples, for the case that the Seg Engine 120 is positioned outside the processing circuit 110, the processing circuit 110 and the Seg Engine 120 can be integrated into an APU, and can be implemented as the processing circuit 110C and the Seg Engine 120C within this APU, respectively. In this architecture, the APU may comprise multiple sub-circuits, and a first sub-circuit and a second sub-circuit among the multiple sub-circuits may act as the processing circuit 110C and the Seg Engine 120C, respectively.

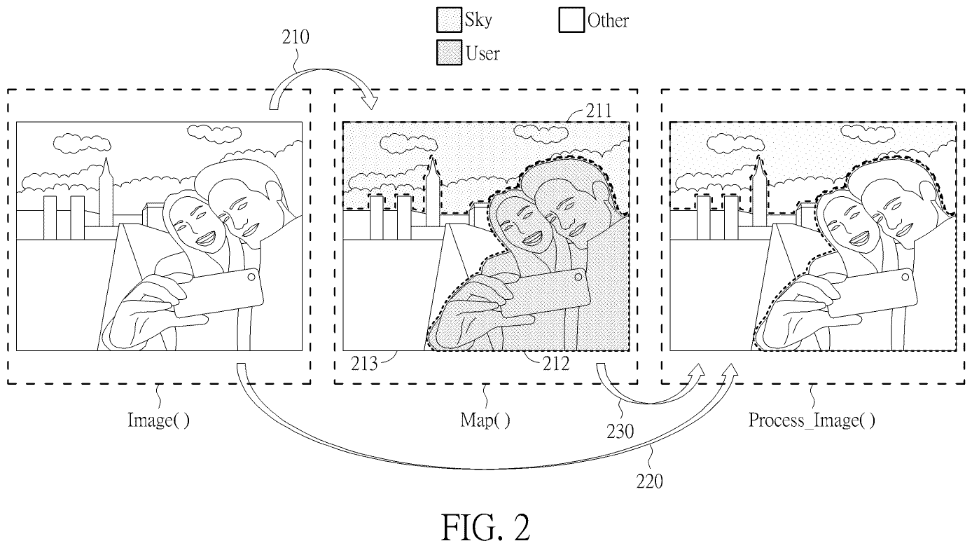

FIG. 2 illustrates a video segmentation and image processing control scheme of the proposed method according to an embodiment of the present invention. Assuming that “n” may represent a non-negative integer, the video may comprise multiple image frames {Image(n)} such as the image frames {Image(n)|n=0, 1, 2, . . . }, and the processing circuit 110 can perform a series of video segmentation operations {210_n|n=0, 1, 2, . . . } on the image frames {Image(n)|n=0, 1, 2, . . . } to generate a series of maps {Map(n)|n=0, 1, 2, . . . }, respectively, and perform a series of image processing operations {220_n|n=0, 1, 2, . . . } on the image frames {Image(n)|n=0, 1, 2, . . . } according to the series of maps {Map(n)|n=0, 1, 2, . . . } in order to generate a series of processed image frames {Process_Image(n)|n=0, 1, 2, . . . } (which may be referred to as the series of processed images {Process_Image(n)|n=0, 1, 2, . . . } for brevity), respectively, and more particularly, perform a series of map delivery operations {230_n|n=0, 1, 2, . . . } for delivering the series of maps {Map(n)|n=0, 1, 2, . . . } to an image signal processing (ISP) module such as an ISP program module, an ISP circuit, etc. (not shown in FIG. 2), respectively, in order to perform the series of image processing operations {220_n|n=0, 1, 2, . . . } by using the ISP module.

In addition, when obtaining (or receiving) any image frame Image(n) among the image frames {Image(n)|n=0, 1, 2, . . . }, the processing circuit 110 can perform the corresponding video segmentation operation 210_n among the series of video segmentation operations {210_n|n=0, 1, 2, . . . } to divide the image frame Image(n) into multiple regions such as the regions 211, 212 and 213 according to certain features such as object boundaries, color, texture, and/or other visual characteristics within the image frame Image(n), and write the associated labels (e.g., the classification labels) into the corresponding map Map(n) among the series of maps {Map(n)|n=0, 1, 2, . . . }, for indicating the classification of the multiple regions such as the regions 211, 212 and 213, respectively. For example, the region 211 may correspond to the sky and may be regarded as the sky area, the region 212 may correspond to one or more users (or the portrait thereof) and may be regarded as the user area or the portrait area, and the region 213 may correspond to some other things and may be regarded as the other area. As a result, the processing circuit 110 can label the multiple regions such as the regions 211, 212 and 213 with multiple labels such as the labels “Sky”, “User” and “Other” in the corresponding map Map(n), respectively. For better comprehension, the image frame Image( ), the map Map( ), and the processed image Process_Image( ) shown in FIG. 2 can be taken as examples of the aforementioned any image frame Image(n) among the image frames {Image(n)|n=0, 1, 2, . . . }, the corresponding map Map(n) among the series of maps {Map(n)|n=0, 1, 2, . . . }, and the corresponding processed image Process_Image(n) among the series of processed images {Process_Image(n)|n=0, 1, 2, . . . }, respectively, and the video segmentation operation 210, the image processing operation 220, and the map delivery operation 230 shown in FIG. 2 can be taken as examples of the corresponding video segmentation operation 210_n among the series of video segmentation operations {210_n|n=0, 1, 2, . . . }, the corresponding image processing operation 220_n among the series of image processing operations {220_n|n=0, 1, 2, . . . }, and the corresponding map delivery operation 230_n among the series of map delivery operations {230_n|n=0, 1, 2, . . . }, respectively, but the present invention is not limited thereto. According to some embodiments, the image frame Image(n), the corresponding map Map(n), the corresponding processed image Process_Image(n), the corresponding video segmentation operation 210_n, the corresponding image processing operation 220_n, and/or the corresponding map delivery operation 230_n may vary.

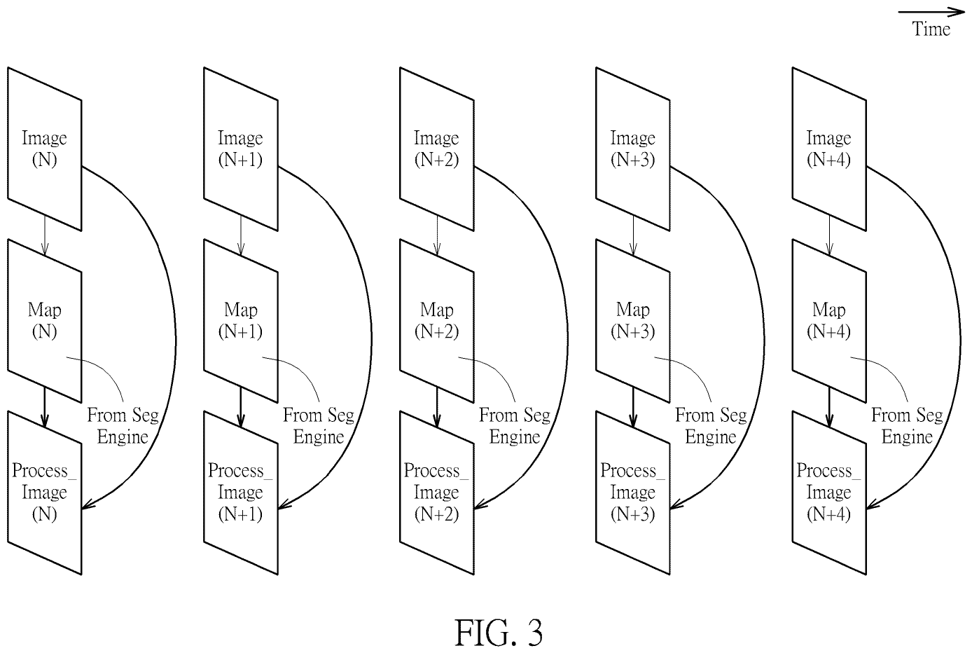

FIG. 3 illustrates some operations in a single type segmentation control scheme according to an embodiment of the present invention. For better comprehension, assume that one or more functions of the apparatus 100 may be temporarily disabled to allow the processing circuit 110 and the Seg Engine 120 to operate according to the single type segmentation control scheme, but the present invention is not limited thereto. As shown in FIG. 3, the horizontal direction may represent the direction of the time axis. For example, the image frame Image(N) may represent a pre-selected image frame Image(n) that is pre-selected from the image frames {Image(n)|n=0, 1, 2, . . . }. Based on the single type segmentation control scheme, at least the maps {Map(n)|n=N, (N+1), (N+2), (N+3), (N+4)} among the series of maps {Map(n)|n=0, 1, 2, . . . }, in particular, all maps {Map(n)} among the series of maps {Map(n)|n=0, 1, 2, . . . }, may be obtained from the Seg Engine 120.

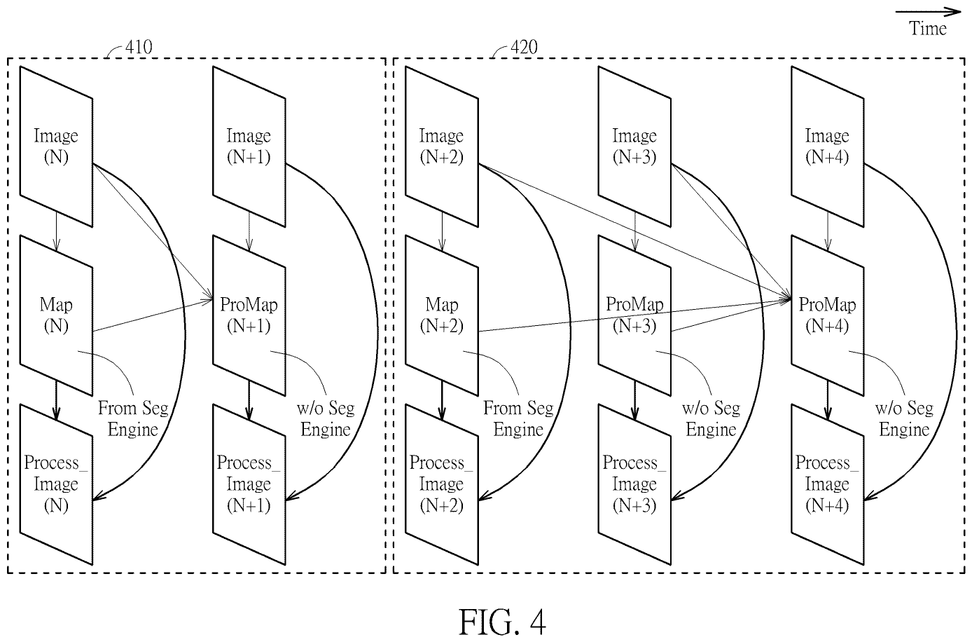

FIG. 4 illustrates some operations in a hybrid type segmentation control scheme of the proposed method according to an embodiment of the present invention. As shown in FIG. 4, the horizontal direction may represent the direction of the time axis. For example, the image frame Image(N) may represent the pre-selected image frame Image(n) that is pre-selected from the image frames {Image(n)|n=0, 1, 2, . . . }. According to this embodiment, at least a portion of maps {Map( )} among the series of maps {Map(n)|n=0, 1, 2, . . . } may be renamed as (or referred to as) the maps {ProMap(n)}, for indicating that these maps {ProMap(n)} are generated without using the Seg Engine 120, while the “Pro” in the symbol “ProMap(n)” thereof may stand for “Proposal” in the proposed method to indicate that these maps {ProMap(n)} are generated from the proposal such as the main program module running on the processing circuit 110 in the proposed architecture. For example, the associated operations of the proposed method may comprise:
(1) the processing circuit 110 can perform a first video segmentation operation on a first image frame (e.g., the image frame Image(N)) of the video with the Seg Engine 120, in order to divide the first image frame (e.g., the image frame Image(N)) into multiple first regions, for performing the image processing of the multiple first regions, respectively; and
(2) the processing circuit 110 can perform a second video segmentation operation on a second image frame (e.g., the image frame Image(N+1) coming after the image frame Image(N)) of the video at least according to correlation information associated with the second image frame and the first image frame (e.g., the image frames Image(N+1) and Image(N)), without using the Seg Engine 120, in order to divide the second image frame (e.g., the image frame Image(N+1)) into multiple second regions, for performing the image processing of the multiple second regions, respectively;
but the present invention is not limited thereto. In some examples, the associated operations of the proposed method may vary. In addition, the correlation information associated with the second image frame and the first image frame may comprise at least one of the following: a difference between the second image frame and the first image frame, motion vector (MV) information derived from the second image frame and the first image frame, or sensor data obtained from at least one sensor (e.g., one or more sensors) of the electronic device capturing the video.

The first video segmentation operation can be performed on the first image frame (e.g., the image frame Image(N)) with the Seg Engine 120 to generate a first map (e.g., the map Map(N)) corresponding to the first video segmentation operation, for indicating the multiple first regions of the first image frame (e.g., the image frame Image(N)), respectively. For the case of n=N, the first video segmentation operation, a first image processing operation such as the image processing of the multiple first regions, and a first map delivery operation can be illustrated with the arrow from the image frame Image(N) to the map Map(N), the arrow from the image frame Image(N) to the processed image Process_Image(N), and the arrow from the map Map(N) to the processed image Process_Image(N), respectively. In addition, the second video segmentation operation can be performed on the second image frame (e.g., the image frame Image(N+1)) at least according to the correlation information associated with the second image frame and the first image frame (e.g., the image frames Image(N+1) and Image(N)) as well as the first map (e.g., the map Map(N)) to generate a second map (e.g., the map ProMap(N+1)) corresponding to the second video segmentation operation, for indicating the multiple second regions of the second image frame (e.g., the image frame Image(N+1)), respectively, where the Seg Engine 120 is arranged to generate the first map (e.g., the map Map(N)), rather than the second map (e.g., the map ProMap(N+1)). More particularly, for the case of n=(N+1), the second video segmentation operation, a second image processing operation such as the image processing of the multiple second regions, and a second map delivery operation can be illustrated with the arrow from the image frame Image(N+1) to the map ProMap(N+1), the arrow from the image frame Image(N+1) to the processed image Process_Image(N+1), and the arrow from the map ProMap(N+1) to the processed image Process_Image(N+1), respectively, and the reference to the correlation information associated with the second image frame and the first image frame (e.g., the image frames Image(N+1) and Image(N)) as well as the first map (e.g., the map Map(N)) for generating the second map (e.g., the map ProMap(N+1)) can be illustrated with the arrows from the image frames Image(N+1) and Image(N) to the map ProMap(N+1) and the arrow from the map Map(N) to the map ProMap(N+1), respectively.

As shown in FIG. 4, along the horizontal direction such as the direction of the time axis, the image frames {Image(n)|n=0, 1, 2, . . . }, the maps {Map(n)} and {ProMap(n)}, the processed images {Process_Image(n)} as well as the associated operations may be divided into multiple groups such as a first group 410 corresponding to {n=N, n=(N+1)}, a second group 420 corresponding to {n=(N+2), n=(N+3), n=(N+4)}, etc. In the first group 410, the map Map(N) is obtained from the Seg Engine 120, but the map ProMap(N+1) is obtained from the proposal such as the main program module running on the processing circuit 110, without (w/o) using the Seg Engine 120 (labeled “w/o Seg Engine” for brevity). In the second group 420, the map Map(N+2) is obtained from the Seg Engine 120, but the maps ProMap(N+3) and ProMap(N+4) are obtained from the proposal such as the main program module running on the processing circuit 110, without (w/o) using the Seg Engine 120 (labeled “w/o Seg Engine” for Brevity).

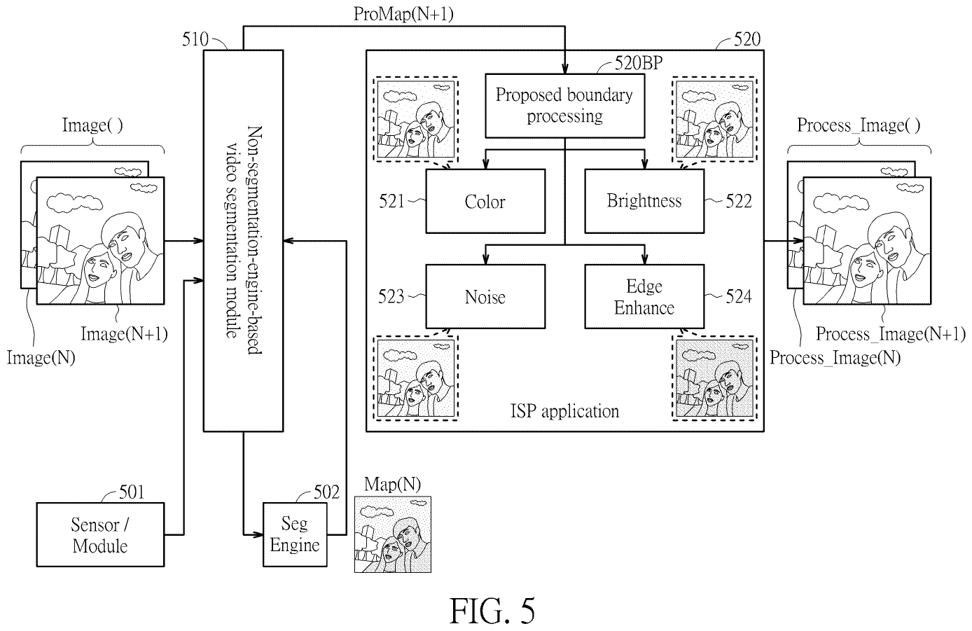

FIG. 5 illustrates a hybrid control architecture involved with the hybrid type segmentation control scheme of the proposed method according to an embodiment of the present invention, where the non-segmentation-engine-based video segmentation module 510 can be taken as an example of the main program module running on the processing circuit 110 in the proposed architecture, the Seg Engine 502 can be taken as an example of the Seg Engine 120, and the ISP application 520 can be taken as an example of the ISP program module mentioned above. As shown in FIG. 5, the ISP application 520 comprises a boundary processing module 520BP and multiple ISP modules such as the ISP modules 521, 522, 523 and 524. The boundary processing module 520BP can be configured to perform boundary processing according to a boundary processing control scheme of the proposed method (labeled “Proposed boundary processing” for better comprehension). In addition, the ISP modules 521, 522, 523 and 524 can be configured to act as the color ISP module, the brightness ISP module, the noise ISP module and the edge enhancement ISP module for performing color processing, brightness processing, noise processing and edge enhancement processing, respectively (labeled “Color”, “Brightness”, “Noise Processing” and “Edge Enhance” respectively for brevity).

For example, the architecture shown in FIG. 5 can operate according to a working flow comprising the following operations:
(1) the non-segmentation-engine-based video segmentation module 510 can run-time detect if the segmentation mask/map (e.g., the map Map(n) or the map ProMap(n)) of the current frame such as the image frame Image(n) is from the Seg Engine 502 or from the non-segmentation-engine-based video segmentation module 510 that is operating according to the proposed method;
(2) the non-segmentation-engine-based video segmentation module 510 can generate the current frame's segmentation mask/map for the ISP application 520, and more particularly, taking the first group 410 shown in FIG. 4 as an example, utilize the map Map(N) as the current frame's segmentation mask/map for the ISP application 520 for the case of n =N or utilize the map ProMap(N+1) as the current frame's segmentation mask/map for the ISP application 520 for the case of n=(N+1); and
(3) the multiple ISP modules such as the ISP modules 521, 522, 523 and 524 can do (or perform) the corresponding image processing thereof such as the color processing, the brightness processing, the noise processing and the edge enhancement processing based on at least the given segmentation mask/map (e.g., the map Map(N) or the map ProMap(N+1)), and more particularly, taking the first group 410 shown in FIG. 4 as an example, perform the corresponding image processing based on the map Map(N) for the case of n=N or perform the corresponding image processing based on the map ProMap(N+1) and the proposed edge processing guidance (e.g., the edge processing guidance obtained from the boundary processing module 520BP) for the case of n=(N+1).

The boundary processing module 520BP can perform the boundary processing on the map ProMap(N+1) (or a portion of labels among all labels recorded thereon) to provide suggestions for adjusting the labels around any object boundary among at least one object boundary (e.g., one or more object boundaries) of the image frame Image(N +1), in order to indirectly update the map ProMap(N+1), with the suggestions acting as the edge processing guidance for the multiple ISP modules such as the ISP modules 521, 522, 523 and 524, but the present invention is not limited thereto. According to some embodiments, the boundary processing module 520BP can perform the boundary processing on the map ProMap(N+1) (or the portion of labels among all labels recorded thereon) to adjust the labels around the aforementioned any object boundary among the aforementioned at least one object boundary of the image frame Image(N+1), in order to directly update the map ProMap(N+1), with the label adjustments acting as the embedded edge processing guidance within the updated map ProMap(N+1) for the multiple ISP modules such as the ISP modules 521, 522, 523 and 524. No matter whether the boundary processing module 520BP is configured to directly or indirectly update the map ProMap(N+1), the multiple ISP modules such as the ISP modules 521, 522, 523 and 524 can perform the corresponding image processing based on the latest updated map ProMap(N+1) which has been updated in accordance with the boundary processing performed by the boundary processing module 520BP.

Some implementation details regarding the Decision of whether the current frame such as the image frame Image(n) is (or should be) processed by the Seg Engine 502 or the non-segmentation-engine-based video segmentation module 510 may be described as follows. According to some embodiments, the first video segmentation operation (e.g., the video segmentation operation 210_N performed on the image frame Image(N)) may belong to multiple segmentation-engine-based video segmentation operations such as the video segmentation operations {210_n} performed by the Seg Engine 502, and the second video segmentation operation (e.g., the video segmentation operation 210_(N+1) performed on the image frame Image(N+1)) may belong to multiple non-segmentation-engine-based video segmentation operations such as the video segmentation operations {210_n} performed by the non-segmentation-engine-based video segmentation module 510, where the multiple segmentation-engine-based video segmentation operations and the multiple non-segmentation-engine-based video segmentation operations may be performed in turn. For example, the multiple segmentation-engine-based video segmentation operations and the multiple non-segmentation-engine-based video segmentation operations can be performed in an interleaving manner according to a pre-defined frame interval. More particularly, the inference by the Seg Engine 120 can be performed by two frames, three frames, or even more frames. In another example, the multiple segmentation-engine-based video segmentation operations and the multiple non-segmentation-engine-based video segmentation operations can be performed in accordance with at least one dynamic frame interval determined by run-time decision. It is content-based decision depending on the motion, the scene such as the luma Y′ (e.g., the brightness in an image, such as the achromatic/black-and-white portion of the image), the scene color, the G/Gyro sensor related information, etc. to decide if the current frame such as the image frame Image(n) is (or should be) processed by the Seg Engine 502 or the non-segmentation-engine-based video segmentation module 510. In the architecture shown in FIG. 5, the aforementioned sensor information such as the G/Gyro sensor related information, etc. can be obtained from one or more corresponding sensors or one or more corresponding sensing modules, which can be collectively referred to as the sensor/module 501. For brevity, similar descriptions for these embodiments are not repeated in detail here.

Some implementation details regarding the Mask/Map Generation may be further described as follows. According to some embodiments, the apparatus 100 can generate the segmentation mask/map by the following two parts:
(1) Generating the segmentation mask/map (e.g., the map Map(N)) for a specific frame such as the image frame Image(N) by the Seg Engine 120 such as the Seg Engine 502, which may be implemented by way of one of the following: the APU (or any sub-circuit thereof), the specific hardware (HW) circuit, the library, etc.; and
(2) Using the current and previous frame difference, the last Seg Engine processed mask/map and the sensor devices information to predict the current segmentation mask/map (e.g., the map ProMap(N+1)).

With the combination of the above two parts, the apparatus 100 (or the main program module running on the processing circuit 110 therein, such as the non-segmentation-engine-based video segmentation module 510) can get the segmentation map of each frame in the video without always calling the Seg Engine 120 such as the Seg Engine 502. For brevity, similar descriptions for these embodiments are not repeated in detail here.

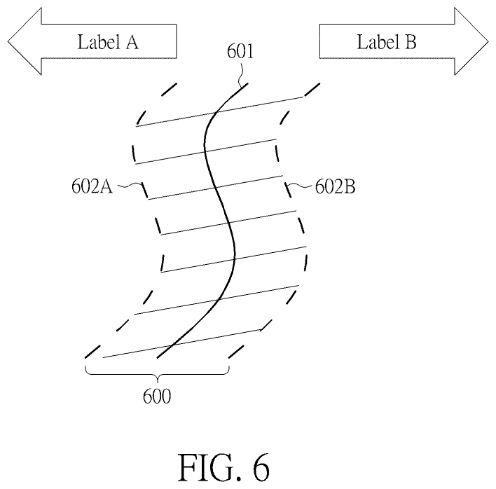

FIG. 6 illustrates the boundary processing control scheme of the proposed method according to an embodiment of the present invention. The proposed boundary processing can provide special handling for the label boundary which fits the image processing requirements based on the luma Y′, the color or any detail information. For example, the processing circuit 110 (or the main program module running thereon, such as the non-segmentation-engine-based video segmentation module 510) can detect that an object boundary 601 of the previous frame such as the image frame Image(N) no longer stays at the original location in the current frame such as the image frame Image(N+1), and more particularly, can detect that the object boundary 601 has become the object boundary 602A or the object boundary 602B with a shift, and control the boundary processing module 520BP to perform at least one of the following operation:
(1) Providing the suggestions for adjusting the labels around the object boundary 602A or the object boundary 602B, in order to indirectly update the map ProMap(N+1), with the suggestions acting as the edge processing guidance for the multiple ISP modules such as the ISP modules 521, 522, 523 and 524; and
(2) Adjusting the labels around the object boundary 602A or the object boundary 602B, in order to directly update the map ProMap(N+1), with the label adjustments acting as the embedded edge processing guidance within the updated map ProMap(N+1) for the multiple ISP modules such as the ISP modules 521, 522, 523 and 524.

No matter whether the boundary processing module 520BP is configured to directly or indirectly update the map ProMap(N+1), the multiple ISP modules such as the ISP modules 521, 522, 523 and 524 can correctly perform the corresponding image processing on the associated region such as the region 600 (in particular, the region 600 that is determined as around or near the object boundary 601, the object boundary 602A and/or the object boundary 602B by the non-segmentation-engine-based video segmentation module 510 and/or by the boundary processing module 520BP) based on the latest updated map ProMap(N+1) which has been updated in accordance with the boundary processing performed by the boundary processing module 520BP. For brevity, similar descriptions for this embodiment are not repeated in detail here.

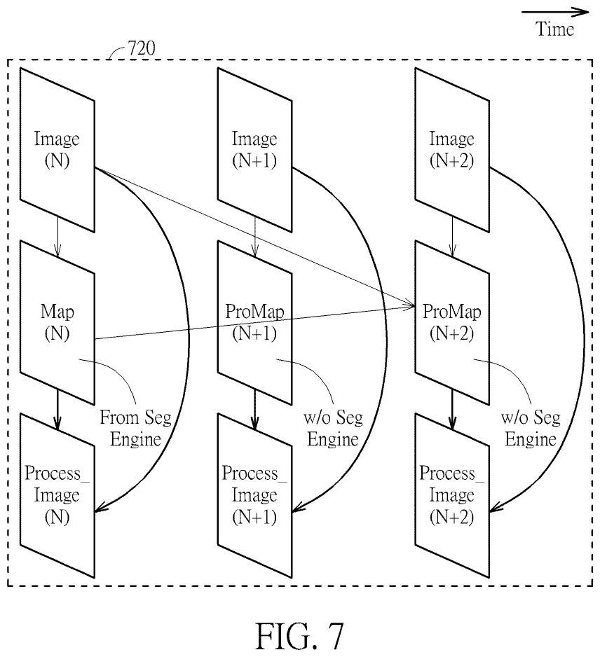

FIG. 7 illustrates some operations in the hybrid type segmentation control scheme of the proposed method according to another embodiment of the present invention. Regarding an extended first group 720 which can be regarded as a group extended from the first group 410 shown in FIG. 4 to become a larger group similar to the second group 420 mentioned above, more than one video segmentation operation can be performed without using the Seg Engine 120. The processing circuit 110 can perform a third video segmentation operation on a third image frame (e.g., the image frame Image(N+2) coming after the image frame Image(N+1)) of the video at least according to correlation information associated with the third image frame and the first image frame (e.g., the image frames Image(N+2) and Image(N)), without using the Seg Engine 120, in order to divide the third image frame (e.g., the image frame Image(N+2)) into multiple third regions, for performing the image processing of the multiple third regions, respectively. In addition, the correlation information associated with the third image frame and the first image frame may comprise at least one of the following: a difference between the third image frame and the first image frame, MV information derived from the third image frame and the first image frame, or sensor data obtained from the aforementioned at least one sensor (e.g., the one or more sensors) of the electronic device capturing the video.

For example, the third video segmentation operation can be performed on the third image frame (e.g., the image frame Image(N+2)) at least according to the correlation information associated with the third image frame and the first image frame (e.g., the image frames Image(N+2) and Image(N)) as well as the first map (e.g., the map Map(N)) to generate a third map (e.g., the map ProMap(N+2)) corresponding to the third video segmentation operation, for indicating the multiple third regions of the third image frame (e.g., the image frame Image(N+2)), respectively. More particularly, for the case of n=(N+2), the third video segmentation operation, a third image processing operation such as the image processing of the multiple third regions, and a third map delivery operation can be illustrated with the arrow from the image frame Image(N+2) to the map ProMap(N+2), the arrow from the image frame Image(N+2) to the processed image Process_Image(N+2), and the arrow from the map ProMap(N+2) to the processed image Process_Image(N+2), respectively, and the reference to the correlation information associated with the third image frame and the first image frame (e.g., the image frames Image(N+2) and Image(N)) as well as the first map (e.g., the map Map(N)) for generating the third map (e.g., the map ProMap(N+2)) can be illustrated with the arrows from the image frames Image(N+2) and Image(N) to the map ProMap(N+2) and the arrow from the map Map(N) to the map ProMap(N+2), respectively. For brevity, similar descriptions for this embodiment are not repeated in detail here.

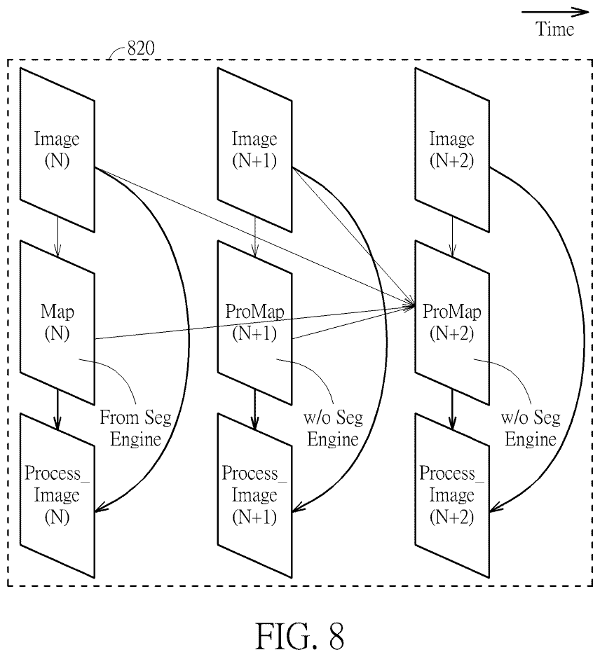

FIG. 8 illustrates some operations in the hybrid type segmentation control scheme of the proposed method according to yet another embodiment of the present invention. Regarding an extended first group 820 which can be regarded as a group extended from the first group 410 shown in FIG. 4 to become a larger group similar to the second group 420 mentioned above, more than one video segmentation operation can be performed without using the Seg Engine 120. The processing circuit 110 can perform the third video segmentation operation on the third image frame (e.g., the image frame Image(N+2) coming after the image frame Image(N+1)) of the video according to the correlation information associated with the third image frame and the first image frame (e.g., the image frames Image(N+2) and Image(N)) and correlation information associated with the third image frame and the second image frame (e.g., the image frames Image(N+2) and Image(N+1)), without using the Seg Engine 120, in order to divide the third image frame (e.g., the image frame Image(N+2)) into multiple third regions, for performing the image processing of the multiple third regions, respectively. In addition, the correlation information associated with the third image frame and the second image frame may comprise at least one of the following: a difference between the third image frame and the second image frame, MV information derived from the third image frame and the second image frame, or sensor data obtained from the aforementioned at least one sensor (e.g., the one or more sensors) of the electronic device capturing the video.

For example, the third video segmentation operation can be performed on the third image frame (e.g., the image frame Image(N+2)) according to the correlation information associated with the third image frame and the first image frame (e.g., the image frames Image(N+2) and Image(N)), the correlation information associated with the third image frame and the second image frame (e.g., the image frames Image(N+2) and Image(N+1)), as well as the first map and the second map (e.g., the maps Map(N) and ProMap(N+1)) to generate a third map (e.g., the map ProMap(N+2)) corresponding to the third video segmentation operation, for indicating the multiple third regions of the third image frame (e.g., the image frame Image(N+2)), respectively. More particularly, for the case of n=(N+2), the third video segmentation operation, the third image processing operation such as the image processing of the multiple third regions, and the third map delivery operation can be illustrated with the arrow from the image frame Image(N+2) to the map ProMap(N+2), the arrow from the image frame Image(N+2) to the processed image Process_Image(N+2), and the arrow from the map ProMap(N+2) to the processed image Process_Image(N+2), respectively, and the reference to the correlation information associated with the third image frame and the first image frame (e.g., the image frames Image(N+2) and Image(N)), the correlation information associated with the third image frame and the second image frame (e.g., the image frames Image(N+2) and Image(N+1)), as well as the first map and the second map (e.g., the maps Map(N) and ProMap(N+1)) for generating the third map (e.g., the map ProMap(N+2)) can be illustrated with the arrows from the image frames Image(N+2) and Image(N) to the map ProMap(N+2), the arrows from the image frames Image(N+2) and Image(N+1) to the map ProMap(N+2), and the arrows from the maps Map(N) and ProMap(N+1) to the map ProMap(N+2), respectively. For brevity, similar descriptions for this embodiment are not repeated in detail here.

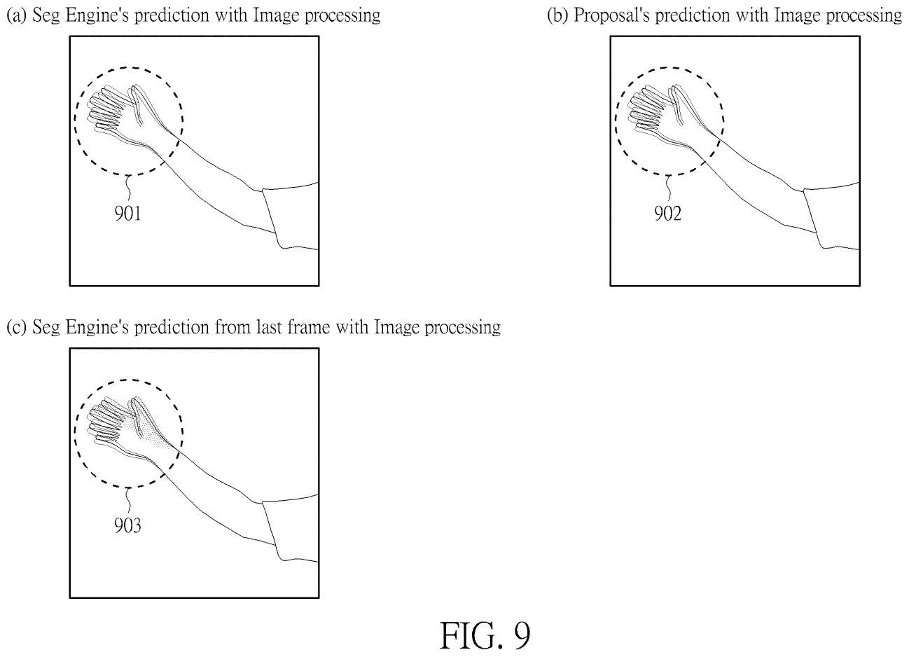

FIG. 9 illustrates, in the sub-diagram (b) thereof, a processing result involved with the hybrid type segmentation control scheme of the proposed method according to an embodiment of the present invention, where some processing result involved with the single type segmentation control scheme and a single type segmentation and power saving control scheme are respectively illustrated in the sub-diagrams (a) and (c) of FIG. 9 for better comprehension. As shown in the sub-diagram (a), the processing result of the Seg Engine's prediction with Image processing may represent the processing result of the image frame Image(N+1) with a moving hand, such as the processed image Process_Image(N+1) (with the moving hand 901) that is obtained from performing the video segmentation operation 210_(N+1) on the image frame Image(N+1) by the Seg Engine 120 to generate the map Map(N+1) (or the classification labels therein) as the prediction regarding the classification of the regions in the image frame Image(N+1), performing the map delivery operation 230_(N+1), and performing the image processing operation 220_(N+1) on the image frame Image(N+1).

As shown in the sub-diagram (b), the processing result of the Proposal's prediction with Image processing may represent the processing result of the image frame Image(N+1) with the moving hand, such as the processed image Process_Image(N+1) (with the moving hand 902) that is obtained from performing the video segmentation operation 210_(N+1) on the image frame Image(N+1) by the proposal such as the main program module running on the processing circuit 110, rather than the Seg Engine 120, to generate the map ProMap(N+1) (or the classification labels therein) as the prediction regarding the classification of the regions in the image frame Image(N+1), performing the map delivery operation 230_(N+1), and performing the image processing operation 220_(N+1) on the image frame Image(N+1). The moving hand 902 in the processing result shown in the sub-diagram (b) and the moving hand 901 in the processing result shown in the sub-diagram (a) look alike, and seem to be equal to each other, indicating that the proposed method can achieve power saving by the selective usage of the Seg Engine 120 (in particular, skip using the Seg Engine 120 upon the Decision mentioned above) without degrading the image processing performance.

Assume that one or more functions of the apparatus 100 may be temporarily disabled to allow the processing circuit 110 and the Seg Engine 120 to operate according to the single type segmentation and power saving control scheme while using the Seg Engine's prediction from the last frame, but the present invention is not limited thereto. As shown in the sub-diagram (c), the processing result of the Seg Engine's prediction from the last frame with Image processing may represent the processing result of the image frame Image(N+1) with the moving hand, such as the processed image Process_Image(N+1) (with the moving hand 903) that is obtained from performing the image processing operation 220_(N+1) on the image frame Image(N+1) according to the map Map(N) (or the classification labels therein) as the prediction regarding the classification of the regions in the image frame Image(N+1), where the map Map(N) is generated according to the last frame such as the image frame Image(N) by the Seg Engine 120. The moving hand 903 in the processing result shown in the sub-diagram (c) looks much worse than the moving hand 902 in the processing result shown in the sub-diagram (b), indicating that the proposed method can achieve better image processing performance than that of the single type segmentation and power saving control scheme.

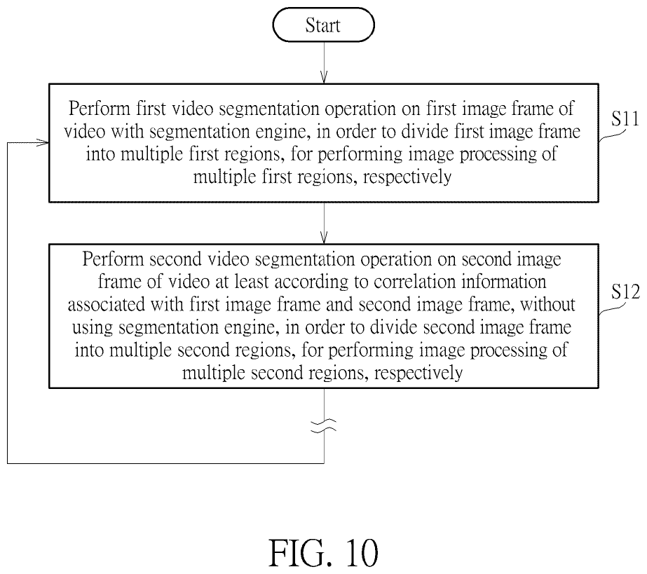

FIG. 10 illustrates a main working flow of the proposed method according to an embodiment of the present invention. The apparatus 100 shown in FIG. 1, as well as the processing circuit 110 and the Seg Engine 120 therein, can operate according to the working flow shown in FIG. 10.

In Step S11, the processing circuit 110 can perform a first video segmentation operation such as the video segmentation operation 210_n on a first image frame such as the image frame Image(n) (e.g., the image frame Image(N), if n=N) of the video with the Seg Engine 120, in order to divide the first image frame (e.g., the image frame Image(N), if n=N) into multiple first regions, for performing the image processing of the multiple first regions, respectively.

In Step S12, the processing circuit 110 can perform a second video segmentation operation such as the video segmentation operation 210_(n+1) on a second image frame such as the image frame Image(n+1) (e.g., the image frame Image(N+1) coming after the image frame Image(N), if n=N) of the video at least according to correlation information associated with the second image frame and the first image frame (e.g., the image frames Image(N+1) and Image(N), if n=N), without using the Seg Engine 120, in order to divide the second image frame (e.g., the image frame Image(N+1), if n=N) into multiple second regions, for performing the image processing of the multiple second regions, respectively.

Taking two neighbor images such as the image frames Image(N) and Image(N+1) in the first group 410 shown in FIG. 4 as an example, the associated processing may comprise the following:
(1) Image(N) processing: The segmentation mask/map of this frame will be processed by the Seg Engine 120, for generating the map Map(N), and the image processing based on the current frame can be referred to as the Process(N) for generating the processed image Process_Image(N); and
(2) Image(N+1) processing: Instead of processing by the Seg Engine 120, for power saving, use the Image(N), Map(N), Image(N+1) relationship(s) such as the relationship(s) between the image frame Image(N), the map Map(N) and the image frame Image(N+1) to generate the map ProMap(N+1);
where the proposed method can provide the segmentation mask/map such as the map ProMap(N+1) by reducing the power-consuming Seg Engine calling times. In addition, Step S11 may be re-entered after the completion of the execution of Step S12, but the present invention is not limited thereto. In some examples, more than one video segmentation operation can be performed without using the Seg Engine 120. For brevity, similar descriptions for this embodiment are not repeated in detail here.

For better comprehension, the method may be illustrated with the working flow shown in FIG. 10, but the present invention is not limited thereto. According to some embodiments, one or more steps may be added, deleted, or changed in the working flow shown in FIG. 10.

According to some embodiments, the first image frame and the second image frame can be two adjacent image frames (e.g., the image frames Image(N) and Image(N+1)) among the multiple image frames {Image(n)} such as the image frames {Image(n)|n=0, 1, 2, . . . }, but the present invention is not limited thereto. According to some embodiments, the first image frame and the second image frame can be two non-adjacent image frames (e.g., the image frames Image(N) and Image(N+2)) among the multiple image frames {Image(n)} such as the image frames {Image(n)|n=0, 1, 2, . . . }. Taking two neighbor images such as the image frames Image(N) and Image(N+2) in the extended first group 720 shown in FIG. 7 as an example, the associated processing may comprise the following:
(1) Image(N) processing: The segmentation mask/map of this frame will be processed by the Seg Engine 120, for generating the map Map(N), and the image processing based on the current frame can be referred to as the Process(N) for generating the processed image Process_Image(N); and
(2) Image(N+2) processing: Instead of processing by the Seg Engine 120, for power saving, use the Image(N), Map(N), Image(N+2) relationship(s) such as the relationship(s) between the image frame Image(N), the map Map(N) and the image frame Image(N+2) to generate the map ProMap(N+2);
where the proposed method can provide the segmentation mask/map such as the map ProMap(N+2) by reducing the power-consuming Seg Engine calling times. In addition, taking three consecutive images such as the image frames Image(N), Image(N+1) and Image(N+2) in the extended first group 820 shown in FIG. 8 as an example, the associated processing may comprise the following:
(1) Image(N) processing: The segmentation mask/map of this frame will be processed by the Seg Engine 120, for generating the map Map(N), and the image processing based on the current frame can be referred to as the Process(N) for generating the processed image Process_Image(N);
(2) Image(N+1) processing: Instead of processing by the Seg Engine 120, for power saving, use the Image(N), Map(N), Image(N+1) relationship(s) such as the relationship(s) between the image frame Image(N), the map Map(N) and the image frame Image(N+1) to generate the map ProMap(N+1); and
(3) Image(N+2) processing: Instead of processing by the Seg Engine 120, for power saving, use at least the Image(N+1), ProMap(N+1), Image(N+2) relationship(s) such as the relationship(s) between the image frame Image(N+1), the map ProMap(N+1) and the image frame Image(N+2), in particular, the Image(N), Map(N), Image(N+1), ProMap(N+1), Image(N+2) relationship(s) such as the relationship(s) between the image frame Image(N), the map Map(N), the image frame Image(N+1), the map ProMap(N+1) and the image frame Image(N+2), to generate the map ProMap(N+2);
where the proposed method can provide the segmentation mask/map such as the map ProMap(N+2) by reducing the power-consuming Seg Engine calling times. For brevity, similar descriptions for these embodiments are not repeated in detail here.

The proposed method and the associated apparatus 100 can provide the segmentation mask/map for video application without inferring each frame by the Seg Engine 120 for power saving. The segmentation mask/map of any image frame Image(n) that is not from the Seg Engine 120 could be reconstructed by the light weight algorithm from historical Seg Engine data and other information such as system information, including but not limited to motion information, various sensor information, etc. In addition, the proposed method and the associated apparatus 100 can make the image processing results in the hybrid type segmentation control scheme almost consistent with that from the Seg Engine 120 in the single type segmentation control scheme.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing video segmentation of a video with selective usage of a segmentation engine, the method comprising:
performing a first video segmentation operation on a first image frame of the video with the segmentation engine, in order to divide the first image frame into multiple first regions, for performing image processing of the multiple first regions, respectively; and
performing a second video segmentation operation on a second image frame of the video at least according to correlation information associated with the second image frame and the first image frame, without using the segmentation engine, in order to divide the second image frame into multiple second regions, for performing image processing of the multiple second regions, respectively.

2. The method of claim 1, wherein the video comprises multiple image frames, and the first image frame and the second image frame are two image frames among the multiple image frames.

3. The method of claim 2, wherein the first image frame and the second image frame are two adjacent image frames among the multiple image frames.

4. The method of claim 2, wherein the first image frame and the second image frame are two non-adjacent image frames among the multiple image frames.

5. The method of claim 2, wherein in addition to the first image frame and the second image frame, the multiple image frames further comprise a third image frame; and the method further comprises:
performing a third video segmentation operation on the third image frame at least according to correlation information associated with the third image frame and the first image frame, without using the segmentation engine, in order to divide the third image frame into multiple third regions, for performing image processing of the multiple third regions, respectively.

6. The method of claim 5, wherein performing the third video segmentation operation on the third image frame at least according to the correlation information associated with the third image frame and the first image frame without using the segmentation engine in order to divide the third image frame into the multiple third regions for performing the image processing of the multiple third regions respectively further comprises:
performing the third video segmentation operation on the third image frame at least according to the correlation information associated with the third image frame and the first image frame and correlation information associated with the third image frame and the second image frame, without using the segmentation engine, in order to divide the third image frame into the multiple third regions, for performing the image processing of the multiple third regions, respectively.

7. The method of claim 1, wherein performing the first video segmentation operation on the first image frame of the video with the segmentation engine in order to divide the first image frame into the multiple first regions for performing the image processing of the multiple first regions respectively further comprises:
performing the first video segmentation operation on the first image frame of the video with the segmentation engine to generate a first map corresponding to the first video segmentation operation, for indicating the multiple first regions of the first image frame, respectively.

8. The method of claim 7, wherein performing the second video segmentation operation on the second image frame of the video at least according to the correlation information associated with the second image frame and the first image frame without using the segmentation engine in order to divide the second image frame into the multiple second regions for performing the image processing of the multiple second regions respectively further comprises:
performing the second video segmentation operation on the second image frame of the video at least according to the correlation information associated with the second image frame and the first image frame as well as the first map to generate a second map corresponding to the second video segmentation operation, for indicating the multiple second regions of the second image frame, respectively.

9. The method of claim 8, wherein the segmentation engine is arranged to generate the first map, rather than the second map.

10. The method of claim 1, wherein the first video segmentation operation belongs to multiple segmentation-engine-based video segmentation operations, and the second video segmentation operation belongs to multiple non-segmentation-engine-based video segmentation operations; and the multiple segmentation-engine-based video segmentation operations and the multiple non-segmentation-engine-based video segmentation operations are performed in turn.

11. The method of claim 10, wherein the multiple segmentation-engine-based video segmentation operations and the multiple non-segmentation-engine-based video segmentation operations are performed in an interleaving manner according to a pre-defined frame interval.

12. The method of claim 10, wherein the multiple segmentation-engine-based video segmentation operations and the multiple non-segmentation-engine-based video segmentation operations are performed in accordance with at least one dynamic frame interval determined by run-time decision.

13. The method of claim 1, wherein the correlation information comprises at least one of the following: a difference between the second image frame and the first image frame, motion vector (MV) information derived from the second image frame and the first image frame, or sensor data obtained from a sensor of an electronic device capturing the video.

14. An apparatus that operates according to the method of claim 1, wherein the apparatus comprises a processing circuit for controlling the video segmentation and selectively using the segmentation engine during the video segmentation.

15. The apparatus of claim 14, wherein the apparatus is implemented as an embedded system.

16. The apparatus of claim 14, wherein the apparatus is implemented as an electronic device.

17. The apparatus of claim 14, wherein the processing circuit and the segmentation engine are implemented by way of at least one integrated circuit (IC).

18. The apparatus of claim 17, wherein the segmentation engine is implemented by way of one of the following: an accelerated processing unit (APU), a specific hardware circuit outside the processing circuit, and a library running on the processing circuit.
